(19) United States
(12) Patent Application Publication
(10) Pub. No.: US 2004/0057451 A1
(43) Pub. Date: Mar. 25, 2004

(54) Method and apparatus for transmitting information via serial bus

(75) Inventors: Takashi Tsuneshige, Tokorozawa-shi (JP); Hirokazu Inotani, Tokorozawa-shi (JP); Masato Hiratsuka, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/660,558

(22) Filed: Sep. 12, 2003

(30) Foreign Application Priority Data
Sep. 20, 2002 (JP) P2002-274619

(51) Int. Cl. H04L 12/42

(52) U.S. Cl. 370/449

(57) ABSTRACT

An information transmitting apparatus (such as player) is provided for transmitting information (audio data, video data, or others) to a plurality of information receiving apparatuses (such as receivers) via a serial bus. The transmitting apparatus has a determination unit and a control unit. The determination unit is configured to determine whether or not one or more of the plurality of information receiving apparatuses are ready for receiving the information. The control unit is configured to make the information refrain from being transmitted by performing a waiting operation until the one of more information receiving apparatuses become ready for receiving the information in cases where the determination unit determines that the one or more information receiving apparatuses are not ready for receiving the information. The waiting operation allows the information transmitting apparatus to send to the information receiving apparatuses the information without dropping out a head portion of the information.

### TECHNICAL FIELD OF THE INVENTION

The present invention relates to a method and apparatus for transmitting information to a plurality of information receiving apparatuses via a serial bus, and an information transmitting and receiving system in which the information transmitting apparatus and the information receiving apparatus are provided.

### BACKGROUND OF THE INVENTION

Recently, a new standard for real-time transmission of information among a plurality of information processing apparatuses (for example, DVD player and receiver) via a serial bus has been published. This standard is known as IEEE 1394 standard (officially known as “IEEE Std. 1394-1995 IEEE Standard for a High Performance Serial Bus”). DVD players and receivers, which are provided with a serial port compliance with such standard, are in the process of being commercialized.

Under the IEEE 1394 standard, a plurality of information processing apparatuses (hereinafter simply noted as “nodes”), such as DVD players and receivers, are connected to each other via a serial bus, and a plurality of channels of information is transmitted between nodes on a time sharing basis. This standard provides the transmission of a maximum 63 channels of information in a system connected via a single serial bus.

The IEEE 1394 standard also provides the execution of initializing a serial bus, which is referred to as bus reset, in cases where a new node is connected to the nodes already connected to the serial bus (i.e., bus connection) or a node is disconnected from such connected nodes (i.e., bus disconnection). After the bus reset, a new serial-bus connection mode (hereinafter, referred to as topology) is built in accordance with predetermined procedures.

When information is actually transmitting after building a topology, a transmission node which tries to start transmitting the information operates as follows. That is, the transmission node manages a communicated state of IRM (Isochronous Resource Manager) nodes (i.e., all the nodes that are present in the built topology). Practically, the communicated state is the number of channels used at each node and a transmission occupying time. Then the transmission node makes inquiry about a current communicated state from other nodes, to nodes that display both currently used channels in a distinguishable manner from other nodes and a transmission occupying time occupied at each current node. If a desired channel and the transmission occupying time are usable, the transmission node obtains the right to transmit information (specifically, the transmission node acquires a desired channel to use and the transmission occupying time later desired), and then starts to transmit information.

Immediately before transmitting the information, the transmission node notifies the IMR nodes that the display states at the IMR nodes are updated. That is, since the transmission of information started by the transmission node changes the channels in use on the serial bus and the transmission occupying time, it is necessary to update the display states into a new communication state in which the changes are reflected. The notified IRM nodes perform the update processing toward their display states, respectively. After this update, the updated display states can be referred from other nodes.

The foregoing transmission occupying time will now be outlined.

Under the IEEE 1394 standard, information is transmitted from each node on the block by the isochronous cycle. The “cycle” is defined by a cycle divided on the time sharing manner applied to the transmission of information via the serial bus. The isochronous cycle is associated with an isochronous transmission region including information to be transmitted in synchronism with information included in other isochronous cycles (for example, image and audio information) and an asynchronous transmission range including information to be transmitted in asynchronism with other information (for example, control information for controlling output of the image and audio information). The isochronous transmission range provides different channels each transmitting different bits of information and each being time-shared, thus making it possible to transmit different bits of information channel by channel.

The foregoing standard also stipulates that the isochronous transmission region has an isochronous cycle whose length is 100 msec at the maximum. Thus a period of time occupied for transmitting bits of information assigned to each channel in the single isochronous transmission range should be within 100 msec in total. This transmission time occupied by each channel in the isochronous cycle corresponds to the transmission occupying time.

By the way, the transmission occupying time is often called differently; i.e., as being a usable band of a serial bus or a usable capacity of a serial bus.

When the isochronous transmission region has an isochronous cycle whose length is less than 100 msec (including zero), the remaining time of the isochronous cycle is dedicatedly used for transmission under the asynchronous transmission range.

If the outlined IEEE 1394 standard is used, independently of attributes of video and audio data to be transmitted, a large amount of bits of information can be transmitted quickly. In addition, it is also possible to transmit other types of information (such as copy control signal) other than video and audio data, whereby the transmission can be done with the copy right of the information fully protected.

Under such circumstances, an audio reproduction system can be provided if the DVD player (hereinafter occasionally referred to as a transmission apparatus) and the receiver (hereinafter occasionally referred to as a reception apparatus) are mutually connected via a serial bus based on the IEEE 1394 standard. In this system, when a play key of the DVD player is pressed so as to reproduce data recorded on a DVD, only audio information is forcibly outputted from its audio output terminal to the receiver.

As described above, the DVD player is preoccupied with transmitting forcibly audio data to a receiver or is configured to simply transmit audio data to a receiver after a predetermined waiting time. Hence, if the receiver is low in its receiving performances, there is a possibility that a head portion of the information that, has been transmitted drops out because of a delayed lock operation (conditional writing).

### SUMMARY OF THE INVENTION

The present invention has been made in view of the above circumstances, and an object of the present invention is therefore to provide an information transmitting apparatus, an information transmitting method, and an information transmitting and receiving system which have the capability of transmitting information, without dropping out a head portion thereof, to a receiver (information receiving apparatus).

In order to realize the above object, as one aspect, the present invention provides an information transmitting apparatus for transmitting information to a plurality of information receiving apparatuses via a serial bus. The information transmitting apparatus comprises a determination unit configured to determine whether or not one or more of the plurality of information receiving apparatuses are ready for receiving the information; and a control unit configured to make the information refrain from being transmitted by performing a waiting operation until the one of more information receiving apparatuses become ready for receiving the information in cases where the determination unit determines that the one or more information receiving apparatuses are not ready for receiving the information.

As another aspect, the present invention provides an information transmitting method of transmitting information to a plurality of information receiving apparatuses via a serial bus. The method comprises the steps of: determining whether or not one or more of the plurality of information receiving apparatuses are ready for receiving the information; and making the information refrain from being transmitted by performing a waiting operation until the one of more information receiving apparatuses become ready for receiving the information in cases where it is determined that the one or more information receiving apparatuses are not ready for receiving the information.

Still, as another aspect, the present invention provides an information transmitting and receiving system comprising one or more transmission apparatuses transmitting information and a plurality of reception apparatuses each receiving the information from the transmission apparatuses a the serial bus. Each of the transmission apparatuses comprises a determination unit configured to determine whether or not one or more of the plurality of reception apparatuses are ready for receiving the information; and a control unit configured to make the information refrain from being transmitted by performing a waiting operation until the one or more reception apparatuses become ready for receiving the information in cases where the determination unit determines that the one or more reception apparatuses are not ready for receiving the information.

### BRIEF DESCRIPTION OF THE DRAWINGS

Other objects and aspects of the present invention will become apparent from the following description and embodiments with reference to the accompanying drawings in which:

FIG. 1 is a block diagram showing the entire configuration of an information reproducing system according to an example of an information transmitting/receiving system according to the invention;

FIG. 2 is a flowchart showing the processing for registering an output audio format of a receiver into a database in the present embodiment;

FIG. 3 illustrates an AV/C packet used by the processing shown in FIG. 2;

FIG. 4 illustrates the AV/C packet used by the processing shown in FIG. 2;

FIG. 5 is a flowchart showing the processing for deciding an apparatus responding to reproduction;

FIG. 6 is a flowchart showing the processing to move to the reproduction;

FIG. 7 is a flowchart showing the processing for responding to the reproduction;

FIG. 8 explains the AV/C packet used in the processing shown in FIG. 7;

FIG. 9 is a flowchart indicating the processing for waiting till a receiver becomes receivable;

FIG. 10 explains the AV/C packet used in the processing shown in FIG. 9;

FIG. 11 explains the AV/C packet used in the processing shown in FIG. 9;

FIG. 12 is a flowchart showing the processing for deciding an output format; and

FIG. 13 is a flowchart showing the processing for lighting up an indicator.

### DETAILED DESCRIPTION OF THE PREFERRED EMBODIMENT

A preferred embodiment of the present invention will now be described with reference to the accompanying drawings.

In the present embodiment, an information reproducing system to which the present invention is applied will now be described, in which the system is provided with a player capable of detecting and outputting bits of information about music from an optical disk such as DVD, a receiver capable of receiving and outputting the music information that has been supplied from the player, and a serial bus connecting the player and the receiver.

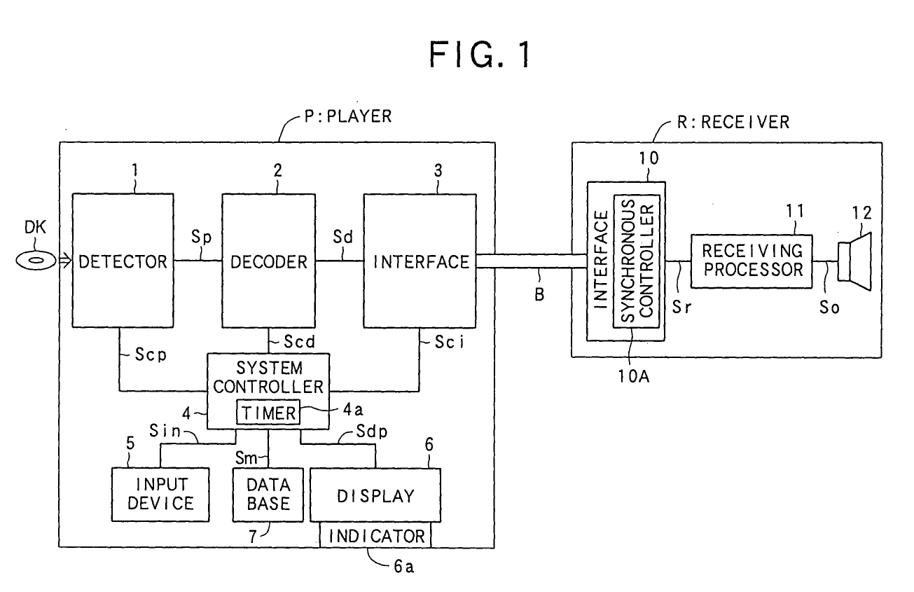

At first, in connection with FIG. 1, the entire configuration and operations of the information reproducing system will now be described.

As shown in FIG. 1, the information reproducing system S according to the present invention is provided with a player P (information transmitting apparatus or transmission apparatus), a receiver R (information receiving apparatus or reception apparatus), and a serial bus B connecting the player P and the receiver R. The system configuration is not limited to that shown in FIG. 1, where both the player P and the receiver R are one in number, respectively. Alternatively, the system may also be equipped with one or more players P and a plurality of receivers R.

The player P is equipped with a detector 1, decoder 2, interface 3, system controller 4, input device 5, display 6, indicator 6a serving as the indicator of the present invention, and database 7.

Meanwhile the receiver R is equipped with an interface 10, receiving processor 11, and speaker 12.

A disk DK can be loaded into the detector 1 of the player P. The disk DK memorizes information indicating a plurality of pieces of music, which form music to be reproduced. In response to a control signal Scp supplied from the system controller 4, the detector 1 detects the music information from the disk DK, and supplies the detected music information to the decoder 2 as music information Sp.

The decoder 2 responds to a control signal Scd coming from the system controller 4 so that preset decoding processing is applied to the music information Sp, thus decoded information Sd being provided to the interface 3.

The interface 3 operates to respond to a control signal Sci from the system controller 4, and applies output interface in compliance with the foregoing serial-bus standard to the decoded information Sd. This processing will produce reproduced information, which is then sent to the serial bus B. The reproduced information includes isochronous packets formed in compliance with the foregoing serial-bus standard. The isochronous packets each include not only the music information reproduced from the disk DK but also control information, such as a synchronization signal used for synchronization control in the receiver R.

The player P has the input device 5 equipped with various devices, such as play key and power supply switch, which are operated by a user at the input device 5 to enter data indicting necessary operations. An operation signal Sin responding to a user's operation is sent from the input device 5 to the system controller 4. Responsively, a memory signal Sm is sent from the database 7 to the system controller 4.

Thus, on the basis of the contents of the operation signal Sin and the memory signal Sm, the system controller 4 produces the foregoing various signals Scp, Scd and Sci for controlling the components of the player P, and provides the components with those signals.

Operational states of the player P are displayed by the display 6 responsively to display information Sdp sent from the system controller 4. The display 6 is provided with the indicator 6a thereon. This indicator 6a is made to be lighted while a connection with the receiver R is established.

In the database 7, there are stored i) data composing the isochronous packets formed based on the serial-bus standard, ii) information indicative of any receiver R selected from a plurality of receivers R (namely, a connection of the selected receiver R with the player P has been established) and entitled to memorize reproduced information transmitted from the player P, and iii) audio formats corresponding to the decoding capability of the receiver R, such as AC-3 (Dolby (registered mark) sound), DTS (Digital Surround Audio), and one bit audio. Thus the database 7 functionally composes a memorization unit of the present invention. The contents of data stored in the database 7 are sustained even if the power is turned off.

In addition, the database 7 composes a memorization unit of the present invention, in which audio formats which can be supported by a receiver R that has established a connection with the player P.

The system controller 4 functionally constitutes a selection unit of the present invention, which is configured to select at least one of the plural receivers R for receiving reproduced information coming from the player P. Further, the system controller 4 functionally constitutes a transmission path establishing unit of the present invention, which makes the selected player P to receive the reproduced information by establishing a connection with the player P. This transmission path establishing unit is able to establish the transmission path by sending a predetermined command to the receiver R.

As another functional configuration, the system controller 4 achieves a search unit of the present invention, which is in charge of searching an audio format supported by a receiver R that has established a connection with the player P. Still, the system controller 4 functionally constitutes a decision unit according to the present invention, which uses the searched results to decide an audio format for the receiver R. This decision is made by making reference to the database 7.

Further, the system controller 4 functionally constitutes not only a determination unit which determines if or not a receiver R that has established a connection with the player P is ready for reception but also a control unit which is responsible for control to make the player P wait for transmission of reproduced information until the receiver R is ready for reception of the reproduced information. The determination unit is configured to perform the determination with reference to a response from the receiver R, which returns responsively to sending the predetermined command to the receiver R.

The system controller 4 includes a timer 4a serving as measurement means. The timer 4a is used to measure a time for making the player 4 wait for the transmission.

When any receiver R has established a connection with the player P, a transmission path is connected on the serial bus B from the player P to the receiver R, whereby the receiver R is able to receive reproduced information from the player P.

Meanwhile, the interface 10 in the receiver R is configured to apply input interfacing processing to the reproduced information that has received via the serial bus B, the input interfacing processing being compliance with the foregoing serial-bus standard. This processing allows the interface 10 to produce bits of information Sr to be sent to the receiving processor 11. A synchronous controller 10a, which is incorporated in the interface 10, adopts a synchronous signal in the isochronous packets as a reference signal and enables the input interfacing processing to be executed, with a synchronous state between the interfaces 10 and 3 maintained.

The receiving processor 11 is configured to perform predetermined reception processing on music data included in the inputted information Sr, thus resultant information So being outputted.

In response to the outputted information So, the speaker 12 outputs music sound that corresponds to music data detected from the disk DK.

The operations carried out in the present embodiment will now be detailed.

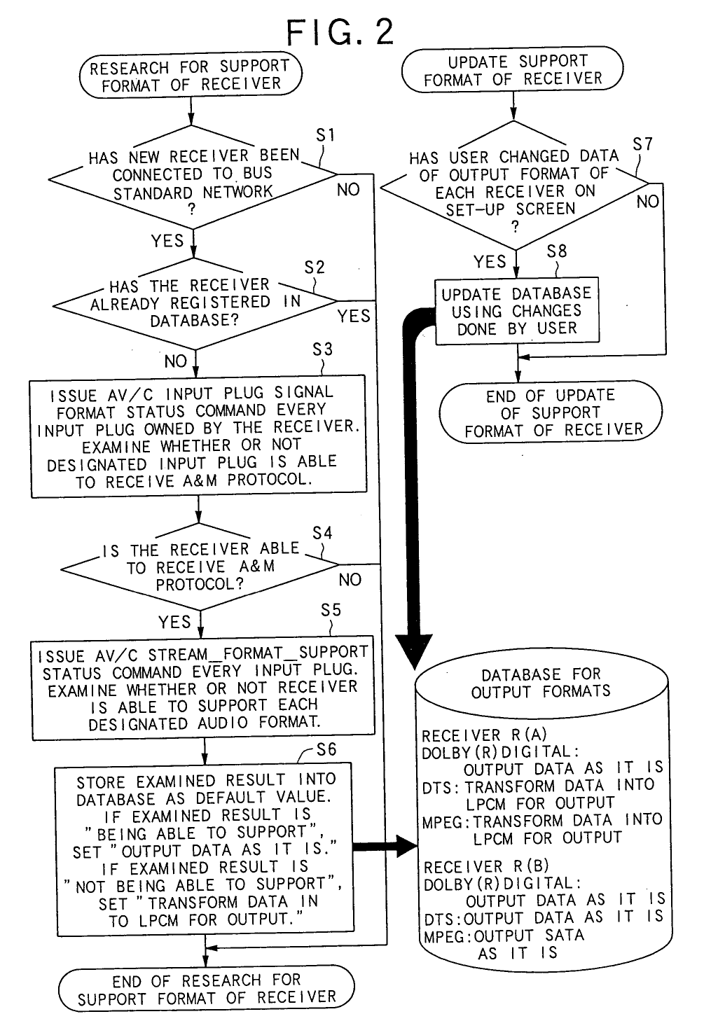

FIG. 2 is a flowchart showing the processing for registering the output audio format of each receiver R into the database 7.

In FIG. 2, the processing for searching a supporting format of a receiver R is first carried out. Specifically, at step S1, it is determined whether or not a receiver R is newly connected to a network in compliance with the IEEE 1394 standard. That is, it is determined if a new receiver R in compliance with the serial-bus standard is connected or not. If such a receiver R has been connected (Yes at step S21), the processing goes to step S2. In contrast, if such a receiver has not been connected (No at step S21), the processing for the research is ended.

At step S2, it is determined whether or not the connected receiver R has already been registered in the database 7. Once such a registration is made (Yes at step S2), the steps following the step S2 will be skipped and goes directly to the end of this processing. If such a registration is yet to be done (No at step S2), the processing for searching the inherent natures of the connected receiver R and registering them into the database 7 is carried out as follow.

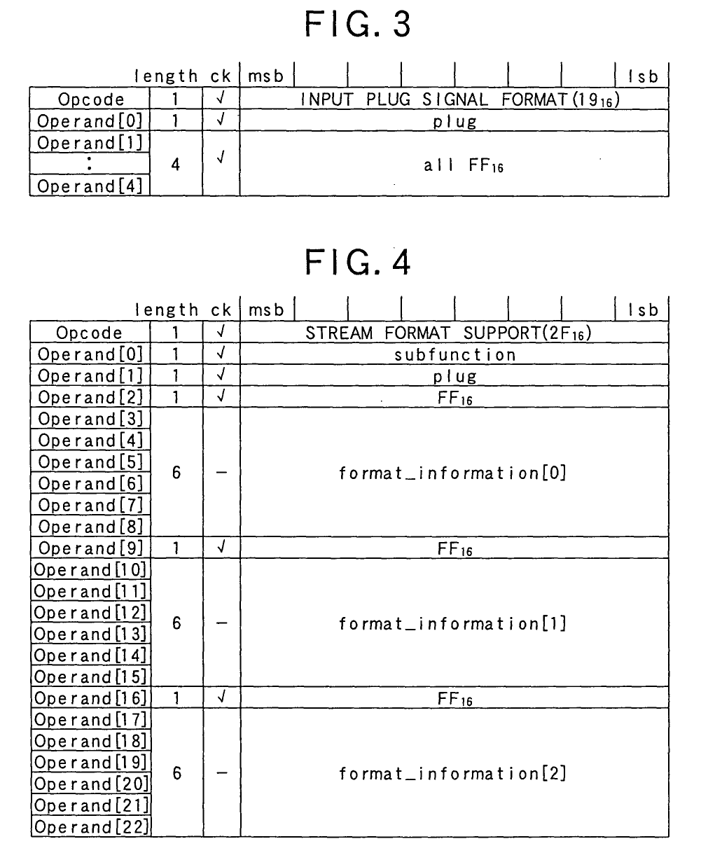

At step S3, as a command for inquiring a state of the receiver R from the outside thereof, an AV/C INPUT_PLUG_SIGNAL_FORMAT status command is issued, which is in compliance with IEEE 1394 standard shown in FIG. 3. Since the receiver R responds to this command, determining the response at the player P allows the player P to know whether or not the receiver R has an input plug for reception of an A & M protocol (Audio and Music Data Transmission Protocol).

Then, at step S4, it is determined whether or not the receiver R to be targeted has one or more input plugs described above. When such an input plug has not been found in the receiver R (No at step S4), the processing is forcibly ended. But when it has been determined that the receiver R has such an input plug (Yes at step S4), the processing goes to step S5.

At step S5, an AV/C STREAM_FORMAT_SUPPORT status command is issued every input plug, which is a command for inquiring the receiver R from the outside thereof and in compliance with IEEE 1394 standard shown in FIG. 4. Since the receiver R having the input plug also responds to this command, determining the response at the player P allows the player P to know whether or not the receiver R supports an audio format specified by the player P. That is, the processing at step S5 provides a search result whether or not the receiver R supports any of the audio formats specified by the player P.

At step S6, with considering the searched result, the player P decides an audio format used when audio data in compliance with the serial-bus standard is outputted to the receiver R, and registers the decided audio format as a default into the database 7. In deciding the audio format, an audio format which can be regarded as being the highest sound quality is selected among the audio formats supported by the receiver R. When the receiver R “supports” the specified audio format, the decided result becomes “output of audio data as it is,” while when the receiver R “does not support” the specified audio format, the decided result becomes “output of audio data converted to LPCM (Linear PCM).”

The processing at step S6 can be exemplified as follows. For instance, assume that the receiver R(A) supports only Dolby (registered trademark) digital. In this case, as to data on Dolby (registered trademark) digital, the data is outputted as it is. However, data DTS and MPEG (Moving Picture Expert Group) which are not supported by the receiver R(A) is converted to LPCM data for the output. Also assume that the receiver R(B) supports DTS and MPEG as well as Dolby (registered trademark) digital. Hence, as to data on Dolby (registered trademark) digital, DTS, or MPEG, the data is outputted as it is.

Since the database 7 is constructed using flash memories (flash PROMs), the registered data therein will not be eliminated during an off-period of the power. On completion of the registration, the processing for searching the supporting formats of the receiver R will be ended.

As shown in FIG. 2, the processing for updating the supporting formats of the receiver R is also carried out. At step S7, a user, who views a setting screen on the display 6, is able to determine whether or not the data indicative of the output audio formats of the receivers registered in the database 7 has already been changed. This user's determination is reflected in the operations toward the player P. Thus, when the data has been changed (Yes at step S7), the processing proceeds to step S8 for updating the data, while when the data has not been changed (No at step S7), the format updating processing is ended.

At step S8, the data contents changed by the user is reflected into the contents currently registered in the database 7, so that the supporting formats of any receiver R can be updated. Then the processing is ended as shown in FIG. 2.

In this way, through the supporting-format search processing and the supporting-format update processing shown in FIG. 2, the player P is able to search if currently connected receivers R support each of audio formats provided by the player P. When detecting a supported audio format, the player P preserves the detected format in the database 7 as a default format used for providing the receiver R with audio data. Later, if necessary, the default format can be customized by the user. For reproducing audio data, the player P searches a receiver R that has established a connection with the player P, and extracts from the database 7 an audio format for the receiver R. Thus the audio format to be used during the transmission is decided.

As a summary, the player P is able to identify a receiver R that has established a connection with the player P itself and to decide an audio format suitable for the receiver R. Hence it is not necessary for the user to set an output audio format to the player P every time the user switches the destination receivers R to be data-transmitted. The operations can therefore be simplified to a greater extent.

This advantage is superior, when compared to the conventional player, in which audio formats supported by a receiver that has established with a connection with the player were not recognized automatically. This was very troublesome in the handling operations. A user has to search in advance, receiver by receiver, audio formats supported by each receiver connected with a player via a serial bus, and add changing operations of the audio formats to the player so that an audio format suitable for the receiver R to be targeted is decided, when reproducing audio data.

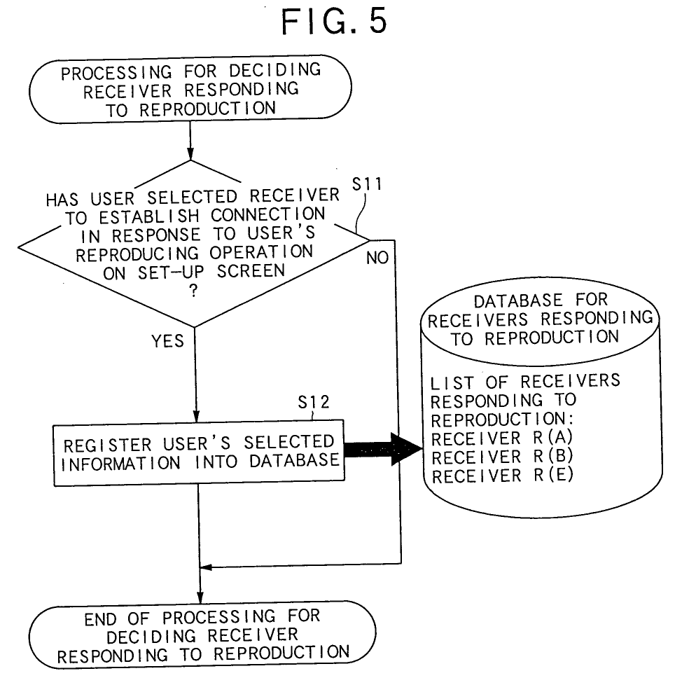

FIG. 5 is a flowchart showing the processing for registering, into the database 7, a receiver R establishing a connection in response to an operation at a play key (i.e., the processing for deciding an apparatus responding to reproduction).

At step S11 in FIG. 5, in response to an operation at the play key, which is performed by a user who views the setting screen on the display 6 on the player P, it is determined if a receiver R to be subjected to establishing the connection has newly selected or not. On the setting screen, the user is entitled to select, if required, plural receivers from a group of receivers R connected to the player P based on the serial-bus standard (that is, data can be transmitted on the A & M protocol).

At step S12, information indicative of one or more receivers selected by the user is registered in the database 7 (composed of flash memories) as a list form, in which the receivers (receiving apparatuses) R(A), R(B), R(C), . . . , R(N) are listed in turn (i.e., a reproduction-responding receiver list is formed). Then this processing is terminated.

As described above, the play key is provided on the setting screen on the display 6 of the player P. Thus, through the performance of the processing shown in FIG. 5, user's operations at the play key make it possible to previously designate one or more receivers R establishing connections with the player P. Accordingly, simply operating the play key will cause the receivers R to establish connections with the player P in an automatic fashion, thus simplifying the operations for setting receivers to be connected. In addition, information about which one or more receivers R are selected is also memorized in the database 7 (composed of flash memories). This means that there is no need for re-setting the list in the database 7 regardless of turning the power on/off in the system.

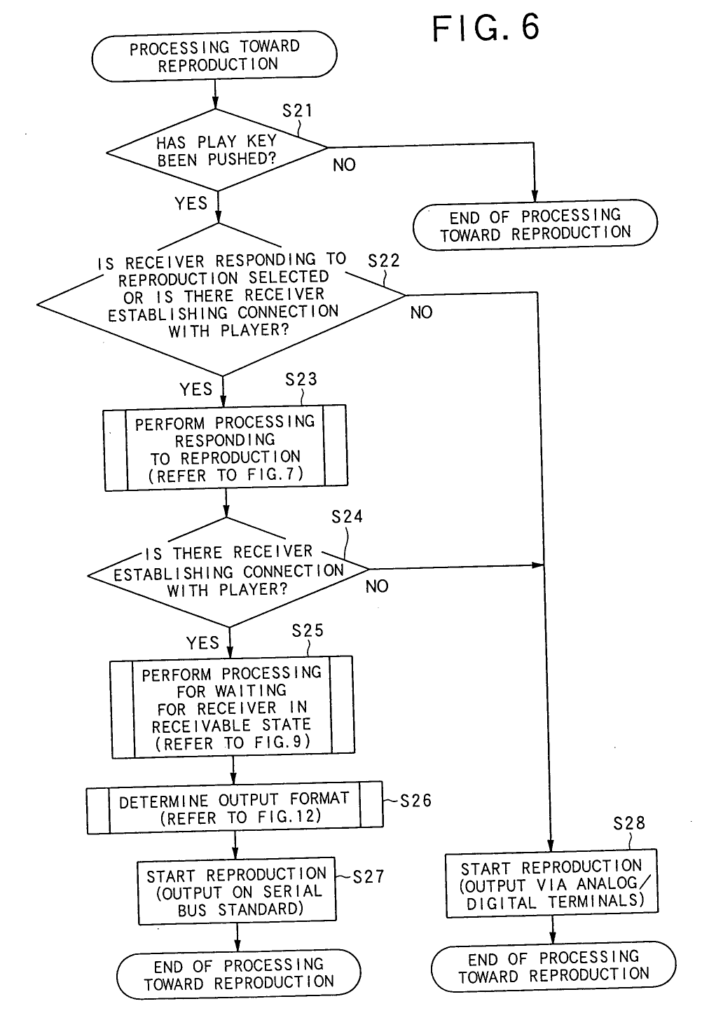

FIG. 6 is a flowchart showing the processing to move to the reproduction.

At step S21 in the processing toward reproduction shown in FIG. 6, it is determined if the play key has been pressed or not. When the play key has been pressed (Yes at step S21), the processing is made to proceed to step S22. But when the play key has not been pressed (No at step S21), the processing to move to the reproduction will be ended.

At step S22, in order to determine whether or not data should be outputted in compliance with the serial-bus standard, it is determined whether or not one or more reproduction-responding receivers R are selected, or, there are one or more receivers R that have established connections with the player P. When a determination result is negative (No at step S22), the processing is made to go to step S28, where the data is outputted to the analog/digital terminals, without being outputted in compliance with the serial-bus standard. On the other hand, when the determination result at step S22 is affirmative (Yes at step S22), the processing is handed to step S23.

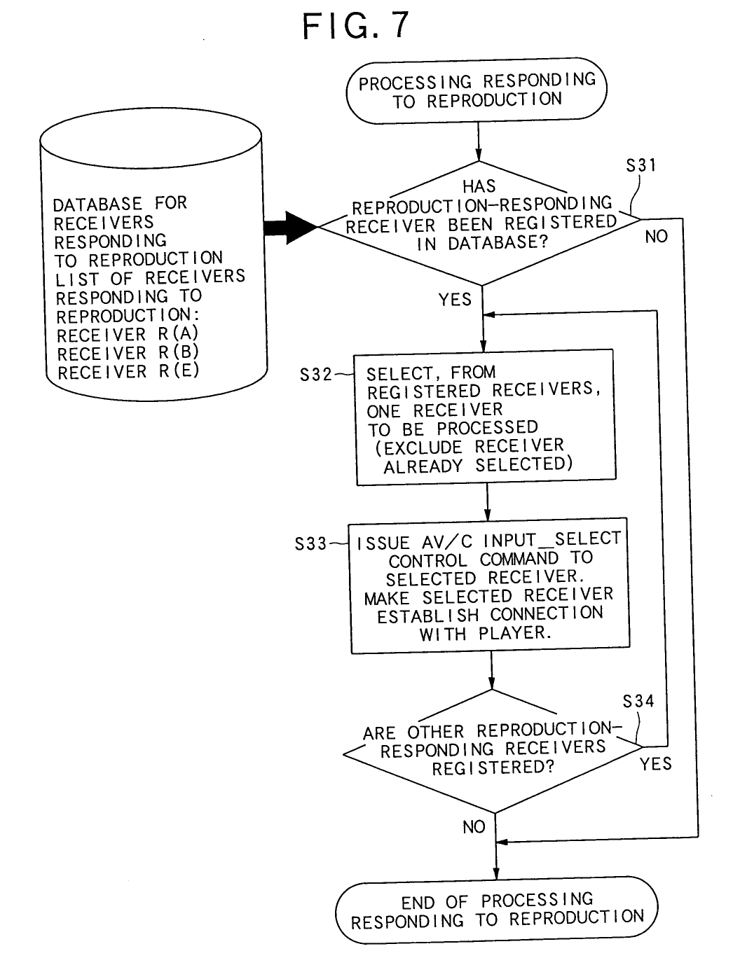

At step S23, the reproduction-responding processing, as shown in FIG. 7 described later, is carried out.

Then the processing is moved to step S24, where it is determined again one or more receivers R has established connections with the player P. When one or more connections have been established (Yes at step S24), the processing goes to step S25. In contrast, there is no establishment of such connections (No at step S24), the processing is moved, like the step S22, to step S28, where the data is outputted to the analog/digital terminals, without being outputted in compliance with the serial-bus standard.

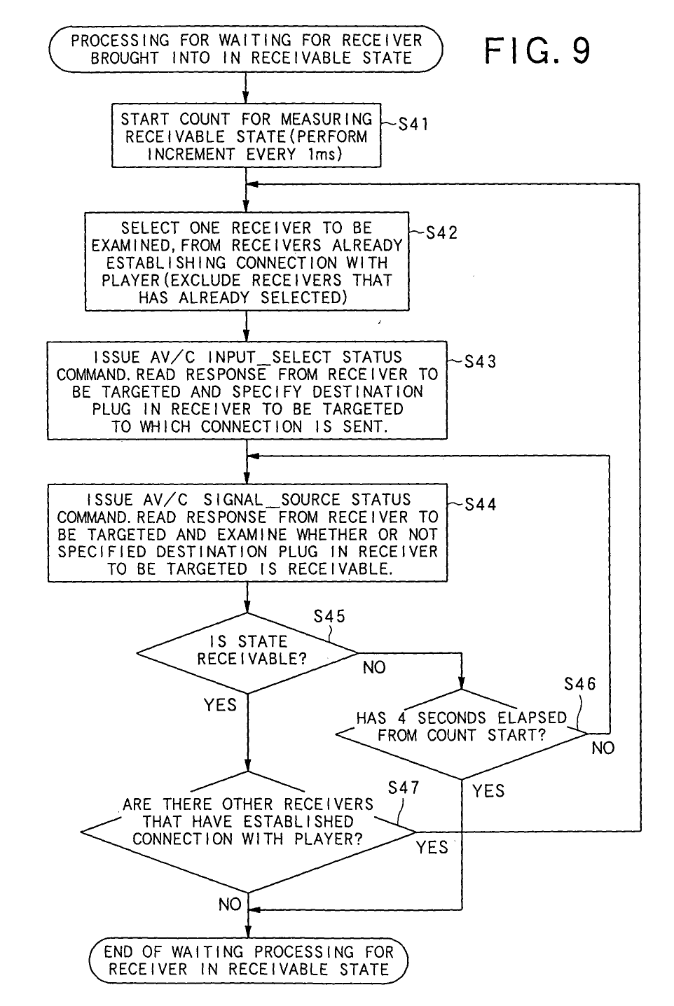

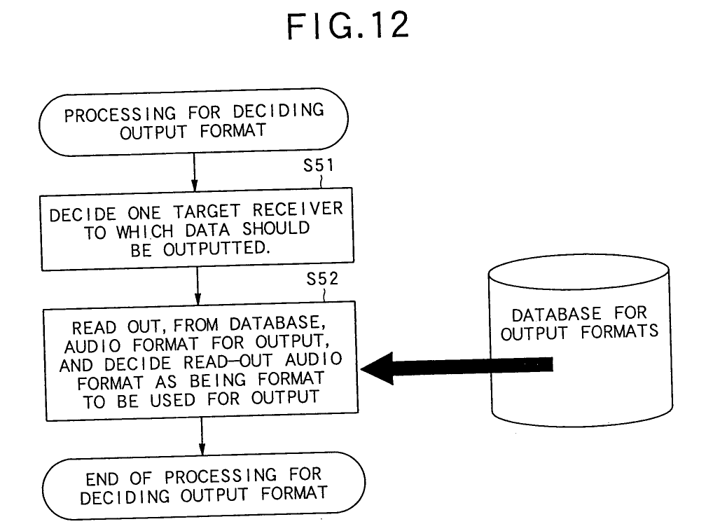

Then, the processing for waiting for receivers in receivable states, which is shown in FIG. 9, is performed at step S25, and the processing for deciding an output format, which is shown in FIG. 12, is performed at step S26. Further, at step S27, the reproduction is started by the player P, before ending the processing to move to the reproduction.

FIG. 7 is a flowchart showing the processing for establishing a connection with a receiver R in response to an operation performed at the play key. This processing intervenes during the operations to move to the reproduction, described above.

The reproduction-responding processing shown in FIG. 7 includes step S31, where it is determined whether or not any receivers R serving as the reproduction-responding receivers are registered in the database 7. If such receivers R are not registered (No at step S31), the reproduction-responding processing is ended. By contrast, if such one or more receivers R are registered (Yes at step S31), the processes on the following steps are performed toward each of those receivers R in the same manner, so that each receiver R establishes a connection with the player P.

First, at step S32, from a group of receivers R registered in the database 7, one receiver R to be targeted at first for the transmission is selected. From this selection process, one or more already-selected receivers are removed.

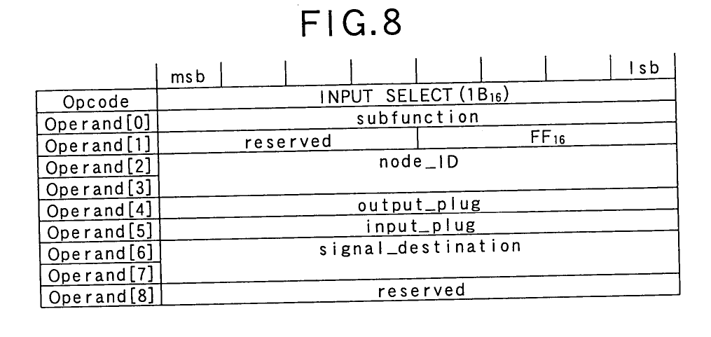

At step S33, the AV/C INPUT_SELECT control command in compliance IEEE 1394 standard is issued to the receiver to be targeted. Thus, this command, which has a function shown in FIG. 8, controls the receiver R from the outside thereof. As a result, the receiver R is allowed to establish a connection with the player P.

Then at step S34, it is determined if there are one or more remaining receivers registered in the database 7, other than the receiver to which the command has been issued at step S33. If such receivers remain (Yes at step S34), the processing is returned to step S32, so that the same command-issuing processing described above is repeated. When it is found that there remains no receiver registered in the database 7 (No at step S34), the reproduction-responding processing is terminated.

In this way, when the reproduction starts in response to a pressing operation at the play key, the processing shown in FIG. 7 allows the player P to establish connections with selected receivers R. Thus, in cases where the connections are established, it is enough for a user to merely press the play key, thus simplifying the operations for the user.

FIG. 9 is a flowchart showing the processing for waiting till each receiver R becomes receivable, this waiting processing being carried out during the processing to move to the reproduction.

When the player P outputs audio data based on the serial-bus standard, only one or more receivers R that have established the connections with the player P receive the outputted audio data. This is illustrated in FIG. 9. Thus, it is required for the player P to examine if or not all the receivers that have established the connections with the player P are ready for the reception of the audio data. This is the waiting processing. When it is found that all the receivers that have established the connections with the player P become receivable for audio data, the waiting processing will be ended. In consideration of malfunctions which may occur at receivers R, a predetermined period of time out (for example, 4 seconds) is set to the waiting processing.

In the waiting processing shown in FIG. 9, at step S41, counting for determining the time out is started. Namely, a count for determining if each receiver R is receivable or not (i.e., a receivable count) is started and subjected to increments every 1 msec.

At step S42, from a group of receivers R that have established the connections with the player P, one receiver R to be targeted at first for the transmission is selected. From this selection process, one or more already-selected receivers are removed.

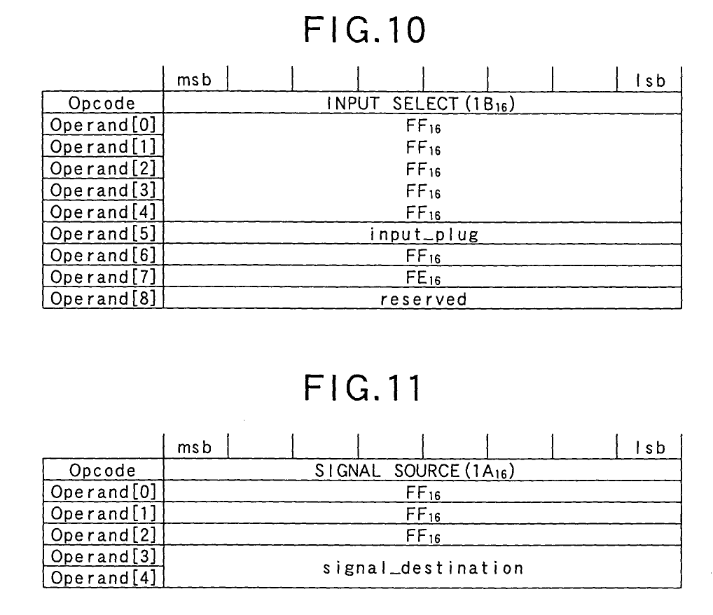

At step S43, the AV/C INPUT_SELECT status command in compliance IEEE 1394 standard is issued to the receiver to be targeted. Thus, this command, which has a function shown in FIG. 10, inquires about the state of the receiver R from the outside thereof. Obtaining a signal destination from the receiver R as a response to the command makes it possible to specify a logical plug (destination plug) of the receiver R to which audio data is inputted. Thus, the destination plug of the receiver to be targeted, with which the connection has been established, can be specified.

At step S44, to examine whether or not the destination plug obtained at step S43 is ready for receiving audio data, an AV/C SIGNAL_SOURCE status command is issued to inquire about a state of the receiver R. This command has a function shown in FIG. 11. As a parameter for the command, the destination plug is specified. Interpreting a response from the receiver R gives information indicative of whether or not the receiver R is receivable. In other words, when a response of signal status=effective(0) is acquired, the receiver R is receivable.

At step S45, it is determined if the receiver R is receivable (i.e. ready for reception) or not. If it is not receivable (No at step S45), the processing is made to go to step S46, where it is determined if or not a time out of 4 seconds elapses. If the time-out condition is yet to be met, the processing is returned to step S44 to issue the command again. In cases where it is determined at step S46 that the time-out period of 4 seconds have elapsed after starting the count, the time out is decided, so that the waiting processing is forcibly ended. The time out is measured by the time 4a (measurement unit) in the system controller 4.

At step S45, the determination shows that the receiver R is in the receivable state, the processing is shifted to step S47, where it is further determined if there are one or more remaining receivers that have established the connections with the player P. If such receivers remain (Yes at step S47), the processing is returned to step S42 to again perform the foregoing waiting processing for each of those remaining receivers R. In the case that there is no receiver R that has established the connection with the player P (No a step S47), the waiting processing will be ended. At this time, all the receivers that have established the connections with the player P are ready for the reception of audio data.

As stated above, the waiting processing shown in FIG. 9 is executed before outputting audio data, so that a waiting operation is continued until all the receivers that have established the connections with the player P are brought into their receivable states. Hence a head portion of audio data to be outputted will not drop out, whereby ensuring that all the data is transmitted from the player P to each receiver R without fail.

FIG. 12 is a flowchart showing the processing for deciding an output audio format for the receivers R that establishes the connections with the player P. This processing is executed during the processing for a reproducing operation.

As shown in FIG. 12, at step S51, of the receivers R that have established the connections with the player P, a single main receiver R is selected as a target receiver.

Then, at step S52, an audio data format used for outputting audio data to the target receiver R selected at step S51 is acquired from the database 7. It is therefore possible to decide a format required for outputting audio data. The output format deciding processing is then ended.

Accordingly, under the deciding processing shown in FIG. 12, a format used for outputting audio data to the receivers R is decided by searching the database 7. Hence, there is no need for re-setting audio formats to the player P every time receivers R are switched one to another, thus facilitating user's operations.

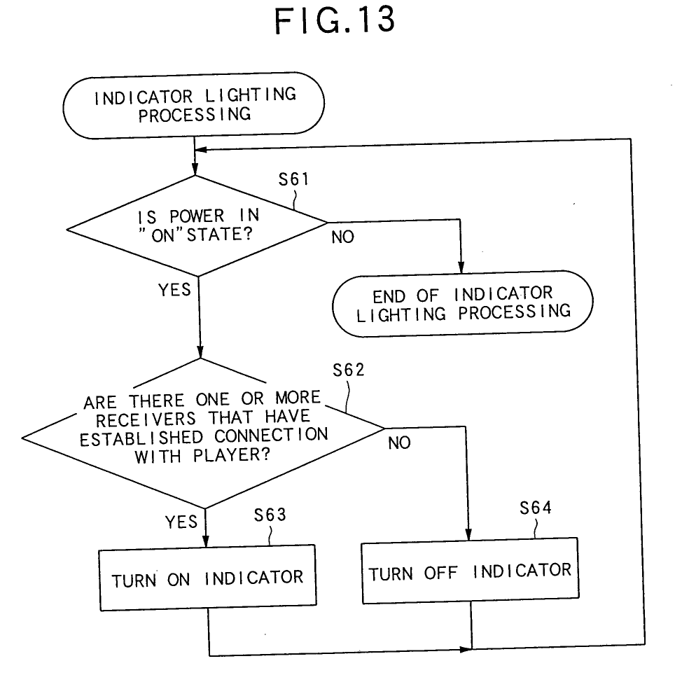

FIG. 13 is a flowchart showing the processing for lighting the indicator 6a to show that one or more connections with one or more receivers R have been established. Thus, the indicator 6a is lit up as long as such connections are kept.

As shown in FIG. 13, at step S61, when the power is in an on-state (Yes at step S61), the indicator 6a is lit up in the following step. In contrast, when the power is in an off-state (No at step S61), the indicator lighting-up processing is terminated.

At step S62, it is determined whether or not there are one or more receivers R that have been subjected to establishment of connections with the player P. If this determination shows the presence of such receivers (Yes at step S62), the processing is made to go to step S63, at which the indicator 6a is lit up. On the other hand, the determination reveals that there is no such receiver (No at step S62), the processing is shifted to step S64, where the indicator 6a is turned off, before returning to step S61 for repetition of the above processing.

Hence, the above indicator lighting-up processing shown in FIG. 13 enables the player P to light up the indicator 6a, as long as one or more connections from one or more receivers R have been established. A user is therefore able to easily notice, without watching receivers R, whether or not audio data is currently subjected to the output operation in compliance with the serial-bus standard.

As described so far, in the present embodiment, in order to receive bits of audio data from the player P, the system controller 4 of the player P operates such that one or more receivers are selected from a plurality of receivers R. The system controller 4 further allows the selected receivers R to be receivable for the audio data. A user is able to perform the above selection of receivers R and setting of receivable receivers R in advance. The operations required for transmission of audio data, which should be done from the player P to the receivers R in response to a user's operations, can be simplified.

Further, for transmitting audio data, only pressing the play key allows one or more receivers R to establish connections with the player P automatically. Thus, user's operations can be simplified and lessened.

Still further, information about the player P with which one or more connections have been established is registered in the database 7. This database 7 sustains its registered information regardless of the on and off operations of the power. Thus, it is unnecessary to re-register the information after the restart of the database 7.

In addition, the system controller obtains formats supported by receivers R that have been ready for reception of music information from the player 4, and, on the basis of the obtained formats, selects formats for outputting (transmitting) the music information to the receivers R. Thus, it is not necessary to re-set such output formats to the player P, even when receivers R to be transmitted are entirely or partly switched to others. The operations from the player P to the receivers R can be simplified. Thus the operations required for users can be simplified and lessened as well.

Furthermore, the player P examines receivers R that have established connections with the player P and waits until those receivers R become ready for reception of audio data. After this waiting operation, audio data is outputted. Thus, a head portion of the audio data is prevented from dropping out, whereby the audio data can surely be transmitted from the player P to each receiver R.

Incidentally, the present invention is not limited to the above information reproducing system provided with the player P, one or more receivers R, and serial bus B. For instance, there can be provided an information transmitting system, in which music information is delivered to the player P via other means and the player P transmits the delivered music information to receivers R. Alternatively, the present invention can be applied to an information transmitting system, in which video information is transmitted from the player P to receivers R.

For the sake of completeness, it should be mentioned that the embodiments and modifications thereof explained so far are not definitive lists of possible embodiments of the present invention. The expert will appreciate that it is possible to combine the various construction details or to supplement or modify them by measures known from the prior art without departing from the basic inventive principle.

The entire disclosure of Japanese Patent Application No. 2002-274619 filed on Sep. 20, 2002 including the specification, claims, drawings and summary is incorporated herein by reference in its entirety.

What is claimed is:

1. An information transmitting apparatus for transmitting information to a plurality of information receiving apparatuses via a serial bus, the information transmitting apparatus comprising:
a determination unit configured to determine whether or not one or more of the plurality of information receiving apparatuses are ready for receiving the information; and
a control unit configured to make the information refrain from being transmitted by performing a waiting operation until the one of more information receiving apparatuses become ready for receiving the information in cases where the determination unit determines that the one or more information receiving apparatuses are not ready for receiving the information.

2. The information transmitting apparatus according to claim 1, further comprising
a measurement unit configured to measure a waiting time during which the waiting operation is performed; and
a transmission unit configured to transmit the information when the waiting time measured by the measurement unit reaches a predetermined value.

3. The information transmitting apparatus according to claim 2, wherein the determination unit is configured to transmit a predetermined command to the plurality of information receiving apparatuses and determines whether or not the one or more information receiving apparatuses are ready for receiving the information on the basis of responses from the one or more information receiving apparatuses that responds to the predetermined command.

4. The information transmitting apparatus according to claim 3, wherein the predetermine command is an AV/C SIGNAL_SOURCE status command in compliance with an IEEE (Institute of Electrical and Electronic Engineers) 1394 standard.

5. The information transmitting apparatus according to claim 1, wherein the determination unit is configured to transmit a predetermined command to the plurality of information receiving apparatuses and determines whether or not the one or more information receiving apparatuses are ready for receiving the information on the basis of responses from the one or more information receiving apparatuses that responds to the predetermined command.

6. The information transmitting apparatus according to claim 5, wherein the predetermine command is an AV/C SIGNAL_SOURCE status command in compliance with an IEEE (Institute of Electrical and Electronic Engineers) 1394 standard.

7. An information transmitting method of transmitting information to a plurality of information receiving apparatuses via a serial bus, the method comprising the steps of:
determining whether or not one or more of the plurality of information receiving apparatuses are ready for receiving the information; and
making the information refrain from being transmitted by performing a waiting operation until the one of more information receiving apparatuses become ready for receiving the information in cases where it is determined that the one or more information receiving apparatuses are not ready for receiving the information.

8. An information transmitting and receiving system comprising one or more transmission apparatuses each transmitting information and a plurality of reception apparatuses each receiving the information from the transmission apparatuses via a serial bus, wherein
each of the transmission apparatuses comprises
a determination unit configured to determine whether or not one or more of the plurality of reception apparatuses are ready for receiving the information; and
a control unit configured to make the information refrain from being transmitted by performing a waiting operation until the one or more reception apparatuses become ready for receiving the information in cases where the determination unit determines that the one or more reception apparatuses are not ready for receiving the information.
